(19) United States
(12) Patent Application Publication
(10) Pub. No.: US 2022/0180703 A1
(43) Pub. Date: Jun. 9, 2022

(54) METHOD OF MODIFYING A WAGER AFTER WAGER STATISTICS ARE DISPLAYED

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/540,781

(22) Filed: Dec. 2, 2021

Related U.S. Application Data
(60) Provisional application No. 63/121,396, filed on Dec. 4, 2020.

(51) Int. Cl. G07F 17/32

(52) U.S. Cl. CPC G07F 17/3244; G07F 17/3288

(57) ABSTRACT

A method of modifying a wager after wager statistics are displayed to a user by allowing a user to confirm a wager, determine the wager statistics for the confirmed wager, displaying the wager statistics to the user, and then providing the user an option to modify the wager resulting in the original wager amount to be deducted in which the deduction goes to the house. In addition, the remaining value of the wager is to be placed on the next play or next available wager within the event, and the odds for the next play are decreased, giving the user the chance to win less money but allowing them to modify their previous wager.

### FIELD

The embodiments are generally related to in-play wagering on live sporting events.

### BACKGROUND

Currently, on wagering platforms or wagering applications, users cannot modify a wager once confirmed.

Also, the only method in which a user can try to modify a wager is to hedge their wager, essentially canceling out any potential win or loss.

Lastly, there is no method in which a user can use wager statistics to modify a wager after the wager has been placed.

### SUMMARY

Methods, systems, and apparatuses for modifying a wager on a wagering network after statistics are displayed via the wagering network may be shown and described. In one embodiment, a method of modifying a wager after wager statistics are displayed on an in-play wagering network can include receiving, from a user device, a wager on a an action of a live sporting event; determining wager statistics related to the wager received from the user device; displaying the wager statistics on the user device; allowing a user associated with the user device to select to modify the wager; and providing a cost to modify the wager and odds for the modified wager.

In another embodiment, a system for modifying a wager after wager statistics are displayed on an in-play wagering network can include a live event upon which play-by-play wagers can be placed; a user device; an in-play wagering network which offers wagers on the live sporting event and is communicatively connected to the user device; a wager module which allows the user device to select a wager on the wagering network, receives wagers from a wager statistics module, and displays wager statistics to the user device; the wager statistics module, which determines wager statistics related to the wager received from the user device; a wager adjustment module which allows the user device to select to modify the wager and determines a cost to modify the wager and odds for the modified wager from a modify database; and the modify database which contains data on the cost to modify the wager and the odds for the modified wager.

### BRIEF DESCRIPTIONS OF THE DRAWINGS

The accompanying drawings illustrate various embodiments of systems, methods, and various other aspects of the embodiments. Any person with ordinary skill in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a system for modifying a wager after wager statistics are displayed, according to an embodiment.

FIG. 2: illustrates a wager module, according to an embodiment.

FIG. 3: illustrates a modify module according to an embodiment.

FIG. 4: illustrates a wager statistics module, according to an embodiment.

FIG. 5: illustrates a wager adjustment module, according to an embodiment.

FIG. 6: illustrates a modify database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “bet” or “wager”. A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog+4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish“, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, or perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are services that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, by creating and delivering actionable insights on performance to help customers to manage the sports gaming. Business Applications can be integrated into the embodiments in a variety of manners.

State based integration allows for a given sports gambling game to be modified by states in the United States or other countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

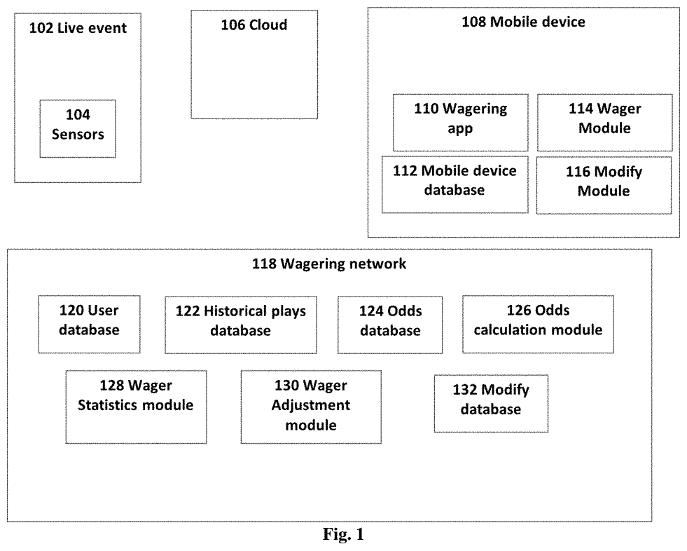

FIG. 1 is a system for modifying a wager after wager statistics are displayed.

This system may include a live event 102, for example, a sporting event such as a football, basketball, baseball, or hockey game, tennis match, golf tournament, eSports or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or an action or series of actions in the live event 102. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 118, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 118 to place bets and provide payment/receive funds based on wager outcomes.

Further, embodiments may include a mobile device database 112 that may store some or all the user's data, the live event 102, or the user's interaction with the wagering network 118.

Further, embodiments may include a wager module 114, which may begin with the user selecting a wagering market. For example, the user selects the Boston Red Sox vs. the New York Yankees event during the J. D. Martinez at-bat in the first inning. Then the user selects a wager on an action or play in the live event. For example, the user selects the wager that J. D. Martinez will hit a single in the first inning at-bat during the Boston Red Sox vs. the New York Yankees event. The user confirms the selected wager. For example, the user confirms the wager that J. D. Martinez will hit a single in the first inning at-bat during the Boston Red Sox vs. the New York Yankees event. Then the wager module 114 sends the confirmed wager to a wager statistics module 128. For example, the wager of J. D. Martinez will hit a single in the first inning at-bat during the Boston Red Sox vs. the New York Yankees event is sent to the wager statistics module 128. Then the wager module 114 continuously polls for the wager statistics from the wager statistics module 128. For example, the wager module 114 continuously polls for the statistics on the sent wager, such as the percent of the wagers on J. D. Martinez hitting a single, double, triple, or home run from other users of the wagering app 110. The wager module 114 receives the wager statistics from the wager statistics module 128. For example, the wager module 114 receives the sent wager statistics, such as the percent of the wagers on J. D. Martinez hitting a single, double, triple, home run, walk, strikeout, groundout, or fly out from other users of the wagering app 110. Then the wager module 114 displays the wager statistics on the wagering app 110. For example, the percentage of the wagers on J. D. Martinez hitting a single, double, triple, or home run from other users of the wagering app 110 are displayed. Then it is determined if the user selects to modify the wager. If it is determined that the user did not select to modify the wager, then the process returns to the user selecting a wagering market. If it is determined that the user selected to modify the wager, then the wager module 114 initiates a modify module 116. For example, the user may wish to modify the confirmed wager of J. D. Martinez will hit a single in the first inning at-bat during the Boston Red Sox vs. the New York Yankees event after seeing the wager statistics. An instance may be if that there is a runner on second and first base is open, there may be greater odds that the result of at-bat would result in a walk and that the majority of other users selected the walk wager and the user wants to modify the wager of the at-bat resulting in a single to take decreased odds on the next play in the event.

Further, embodiments may include the modify module 116, which may begin with the modify module 116 being initiated by the wager module 114. Then the modify module 116 sends the wager data to a wager adjustment module 130. For example, the wager data may be the user ID, such as JS123456, the wagered amount, such as $20, and the wager, such as J. D. Martinez, will hit a single in the first inning at-bat during the Boston Red Sox vs. the New York Yankees event. Then the modify module 116 continuously polls for the cost to modify the wager, the wager amount remaining, and the odds for the next play. For example, the modify module 116 continuously polls for the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The modify module 116 receives the cost to modify the wager, the wager amount remaining, and the odds for the next play. For example, the modify module 116 receives the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. Then the user selects the new wager. For example, the user selects that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. The user confirms the new wager. For example, the user confirms the wager that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. Then the modify module 116 sends the new wager to the wager adjustment module 130. For example, the modify module 116 sends the wager that Xander Bogaerts will hit a single with the odds of 5.1:1 for $15.50 in the Boston Red Sox vs. the New York Yankees event. Then the modify module 116 ends.

Further, embodiments may include the wagering network 118, which may perform real-time analysis on the type of play and the result of a play or action. The wagering network 118 (or the cloud 106) may also be synchronized with game situational data, such as the time of the game, the score, location on the field, weather conditions, and the like, which may affect the choice of play utilized. For example, in an exemplary embodiment, the wagering network 118 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 118 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 120, which may contain data relevant to all users of the wagering network 118 and may include, but is not limited to, a user ID, a device identifier, a paired device identifier, wagering history, or wallet information for the user. The user database 120 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 120 may contain betting lines and search queries. The user database 120 may be searched based on a search criterion received from the user. Each betting line may include, but is not limited to, a plurality of betting attributes such as at least one of the live event 102, a team, a player, an amount of wager, etc. The user database 120 may include but is not limited to information related to all the users involved in the live event 102. In one exemplary embodiment, the user database 120 may include information for generating a user authenticity report and a wagering verification report. Further, the user database 120 may be used to store user statistics like, but not limited to, the retention period for a particular user, frequency of wagers placed by a particular user, the average amount of wager placed by each user, etc.

Further, embodiments may include a historical plays database 122 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 124—that contains the odds calculated by an odds calculation module 126—to display the odds on the user's mobile device 108 and take bets from the user through the mobile device wagering app 110.

Further, embodiments may include the odds calculation module 126, which utilizes historical play data to calculate odds for in-play wagers.

Further, embodiments may include the wager statistics module 128, which may begin with the wager statistics module 128 continuously polling for the wager data from the wager module 114. For example, the wager statistics module 128 continuously polls for the user's wager that J. D. Martinez will hit a single in the first inning at-bat during the Boston Red Sox vs. the New York Yankees event. Then the wager statistics module 128 receives the wager data from the wager module 114. For example, the wager statistics module 128 receives the wager that J. D. Martinez will hit a single in the first inning at-bat during the Boston Red Sox vs. the New York Yankees event. The wage statistics module 128 determines the wager statistics for the confirmed wager. For example, the wager statistics module 128 may determine the number of users that placed a wager for J. D. Martinez to hit a single in the first inning in the Boston Red Sox vs. the New York Yankees event. The wager statistics module 128 may determine this by filtering the odds database 124 for all the wagers placed on the J. D. Martinez at-bat and counting one for each wager, then filter the wagers for the result to be J. D. Martinez hitting a single and count one for each wager, then divide the total amount of wagers resulting in a single by the total amount of wagers placed to determine the percentage of how many users wagered for J. D. Martinez to hit a single. In some embodiments, the statistics may be presented for all the possible outcomes of the at-bat, such as single, double, triple, home run, walk, strikeout ground out, or fly out and these may be calculated using the same method to determine the percentages of users that placed those wagers. In some embodiments, the statistics may involve how much money was wagered on each wager, the increase or decrease percentages of the odds since the wagers were offered, the amount of time the wagers have been offered, etc. Then the wager statistics module 128 sends the wager statistics to the wager module 114, and the process returns to continuously polling for the wager data from the wager module 114. For example, the wager statistics module 128 sends the wager statistics, such as the percent of the wagers on J. D. Martinez hitting a single, double, triple, home run, walk, strikeout, groundout, or fly out other users of the wagering app 110.

Further, embodiments may include the wager adjustment module 130, which may begin with the wager adjustment module 130 continuously polling for the wager data from the modify module 116. For example, the wager data may be the user ID, such as JS123456, the wagered amount, such as $20, and the wager, such as J. D. Martinez, will hit a single in the first inning at-bat during the Boston Red Sox vs. the New York Yankees event. Then the wager adjustment module 130 receives the wager data from the modify module 116. For example, the wager data may be the user ID, such as JS123456, the wagered amount, such as $20, and the wager, such as J. D. Martinez, will hit a single in the first inning at-bat during the Boston Red Sox vs. the New York Yankees event. The wager adjustment module 130 compares the wager data to a modify database 132. For example, the wager adjustment module 130 compares the original wagered amount, such as $20, to the modify database 132 to determine the corresponding cost to modify, such as $4.50, and the percentage to decrease the odds on the next play by, such as 15%. Then the wager adjustment module 130 extracts the cost for modifying the wager. For example, the wager adjustment module 130 extracts the corresponding cost to modify the wager. For example, if the user wagered $20, the cost to modify would be $4.50. Then the wager adjustment module 130 determines the wager amount remaining. For example, the wager adjustment module 130 subtracts the cost to modify, such as $4.50, from the original amount wagered, such as $20, resulting in a $15.50 amount remaining for the user to wager on the next play. The wager adjustment module 130 extracts the percentage to decrease the odds from the modify database 132. For example, the wager adjustment module 130 extracts the corresponding percentage to decrease the odds for the next play. For example, if the user wagered $20, the odds would decrease by 15% on the next play. Then the wager adjustment module 130 extracts the odds for the next wager in the odds database 124. For example, the next play may the at-bat for Xander Bogaerts in the first inning in the Boston Red Sox vs. the New York Yankees, with the odds for Xander Bogaerts to hit a single being 6:1. In some embodiments, the odds may also include for Xander Bogaerts to hit a single, double, triple, home run, walk, strikeout, ground out, or flyout. The wager adjustment module 130 determines the new odds for the next wager. For example, if the odds for Xander Bogaerts to hit a single were 6:1, they would be decreased by 15%, creating new odds for user ID JS12345 of 5.1:1. Then the wager adjustment module 130 sends the cost for modifying the wager, the wager amount remaining, and the odds for the next wager to the modify module 116. For example, the wager adjustment module 130 the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The wager adjustment module 130 is continuously polling for the new wager data from the modify module 116. For example, the wager adjustment module 130 is continuously polling for the new wager data, such as $15.50 on 5.1:1 for Xander Bogaerts to hit a single in the first inning of the Boston Red Sox vs. the New York Yankees event. Then the wager adjustment module 130 receives the new wager data from the modify module 116. For example, the wager adjustment module 130 receives the new wager data, such as $15.50 on 5.1:1 for Xander Bogaerts to hit a single in the first inning of the Boston Red Sox vs. the New York Yankees event. The wager adjustment module 130 stores the new wager data in the user database 120, and the process returns to continuously polling for the wager data from the modify module 116.

Further, embodiments may include the modify database 132. The database may contain the original wager amount, the cost to modify the wager, and the percentage to decrease the odds by. In some embodiments, the cost to modify the wager may be a percentage of the original amount or a predetermined number. In some embodiments, the percentage to decrease the odds may be determined based on the original odds. For example, the higher the odds, the more they are decreased. In some embodiments, the database may contain a list of available wagers that the user can wager to prevent the user from selecting wagers with uncommonly high odds. Finally, in some embodiments, the database may contain a limit on the number of times a user can modify a wager.

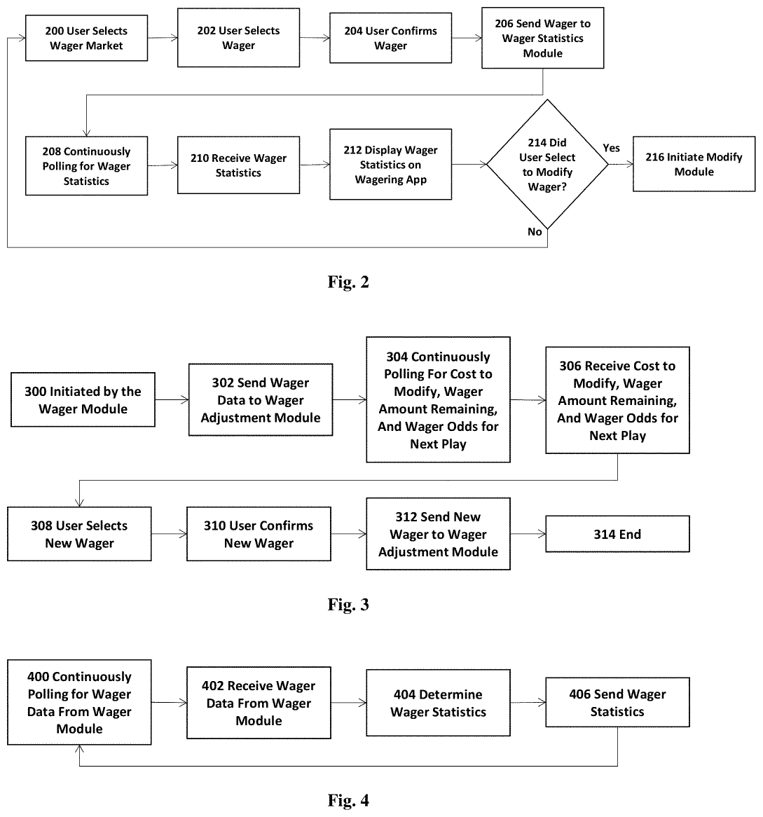

FIG. 2 illustrates the wager module 114. The process begins with the user selecting, at step 200, a wagering market. For example, the user selects the Boston Red Sox vs. the New York Yankees event during the J. D. Martinez at-bat in the first inning. Then the user selects, at step 202, a wager. For example, the user selects the wager that J. D. Martinez will hit a single in the first inning at-bat during the Boston Red Sox vs. the New York Yankees event. The user confirms, at step 204, the selected wager. For example, the user confirms the wager that J. D. Martinez will hit a single in the first inning at-bat during the Boston Red Sox vs. the New York Yankees event. Then the wager module 114 sends, at step 206, the confirmed wager to the wager statistics module 128. For example, the wager of J. D. Martinez will hit a single in the first inning at-bat during the Boston Red Sox vs. the New York Yankees event is sent to the wager statistics module 128. Then the wager module 114 is continuously polled, at step 208, for the wager statistics from the wager statistics module 128. For example, the wager module 114 continuously polls for the statistics on the sent wager, such as the percent of the wagers on J. D. Martinez hitting a single, double, triple, or home run from other users of the wagering app 110. The wager module 114 receives, at step 210, the wager statistics from the wager statistics module 128. For example, the wager module 114 receives the sent wager statistics, such as the percent of the wagers on J. D. Martinez hitting a single, double, triple, home run, walk, strikeout, groundout, or fly out from other users of the wagering app 110. Then the wager module 114 displays, at step 212, the wager statistics on the wagering app 110. For example, the percentage of the wagers on J. D. Martinez hitting a single, double, triple, or home run from other users of the wagering app 110 are displayed. Then it is determined, at step 214, if the user selects to modify the wager. If it is determined that the user did not select to modify the wager, then the process returns to the user selecting a wagering market. If it is determined that the user selected to modify the wager, then the wager module 114 initiates, at step 216, the modify module 116. For example, the user may wish to modify the confirmed wager of J. D. Martinez will hit a single in the first inning at-bat during the Boston Red Sox vs. the New York Yankees event after seeing the wager statistics. An instance may be if that there is a runner on second and first base is open, there may be greater odds that the result of at-bat would result in a walk and that most other users selected the walk wager and the user wants to modify the wager of the at-bat resulting in a single to take decreased odds on the next play in the event.

FIG. 3 illustrates the modify module 116. The process begins with the modify module 116 being initiated, at step 300, by the wager module 114. Then the modify module 116 sends, at step 302, the wager data to the wager adjustment module 130. For example, the wager data may be the user ID, such as JS123456, the wagered amount, such as $20, and the wager, such as J. D. Martinez, will hit a single in the first inning at-bat during the Boston Red Sox vs. the New York Yankees event. Then the modify module 116 continuously polls, at step 304, for the cost to modify the wager, the wager amount remaining, and the odds for the next play. For example, the modify module 116 continuously polls for the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The modify module 116 receives, at step 306, the cost to modify the wager, the wager amount remaining, and the odds for the next play. For example, the modify module 116 receives the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. Then the user selects, at step 308, the new wager. For example, the user selects that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. The user confirms, at step 310, the new wager. For example, the user confirms the wager that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. Then the modify module 116 sends, at step 312, the new wager to the wager adjustment module 130. For example, the modify module 116 sends the wager that Xander Bogaerts will hit a single with the odds of 5.1:1 for $15.50 in the Boston Red Sox vs. the New York Yankees event. Then the modify module 116 ends at step 314.

FIG. 4 illustrates the wager statistics module 128. The process begins with the wager statistics module 128 continuously polling, at step 400, for the wager data from the wager module 114. For example, the wager statistics module 128 continuously polls for the user's wager that J. D. Martinez will hit a single in the first inning at-bat during the Boston Red Sox vs. the New York Yankees event. Then the wager statistics module 128 receives, at step 402, the wager data from the wager module 114. For example, the wager statistics module 128 receives the wager that J. D. Martinez will hit a single in the first inning at-bat during the Boston Red Sox vs. the New York Yankees event. The wage statistics module 128 determines, at step 404, the wager statistics for the confirmed wager. For example, the wager statistics module 128 may determine the number of users that placed a wager for J. D. Martinez to hit a single in the first inning in the Boston Red Sox vs. the New York Yankees event. The wager statistics module 128 may determine this by filtering the odds database 124 for all the wagers placed on the J. D. Martinez at-bat and counting one for each wager, then filter the wagers for the result to be J. D. Martinez hitting a single and count one for each wager, then divide the total amount of wagers resulting in a single by the total amount of wagers placed to determine the percentage of how many users wagered for J. D. Martinez to hit a single. In some embodiments, the statistics may be presented for all the possible outcomes of the at-bat, such as single, double, triple, home run, walk, strikeout ground out, or fly out and these may be calculated using the same method to determine the percentages of users that placed those wagers. In some embodiments, the statistics may involve how much money was wagered on each wager, the increase or decrease percentages of the odds since the wagers were offered, the amount of time the wagers have been offered, etc. Then the wager statistics module 128 sends, at step 406, the wager statistics to the wager module 114, and the process returns to continuously polling for the wager data from the wager module 114. For example, the wager statistics module 128 sends the wager statistics, such as the percent of the wagers on J. D. Martinez hitting a single, double, triple, home run, walk, strikeout, groundout, or fly out other users of the wagering app 110.

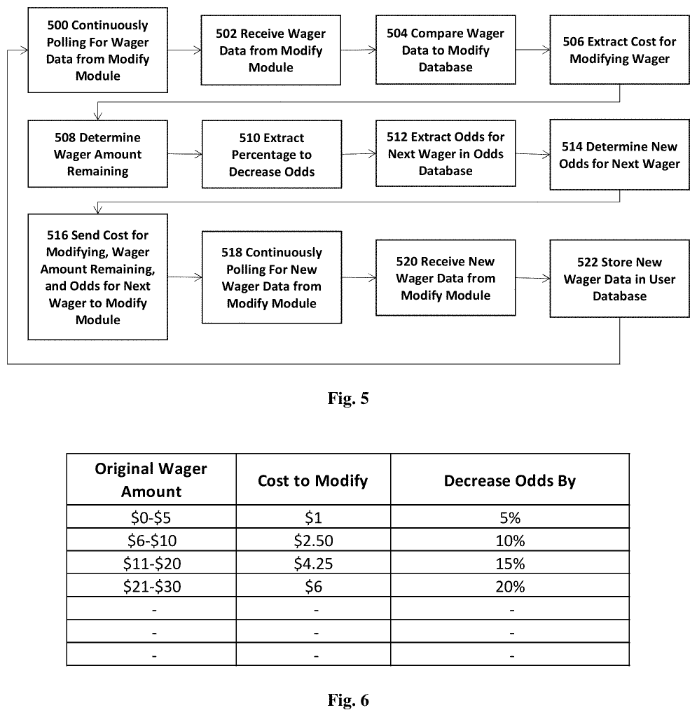

FIG. 5 illustrates the wager adjustment module 130. The process begins with the wager adjustment module 130 continuously polling, at step 500, for the wager data from the modify module 116. For example, the wager data may be the user ID, such as JS123456, the wagered amount, such as $20, and the wager, such as J. D. Martinez, will hit a single in the first inning at-bat during the Boston Red Sox vs. the New York Yankees event. Then the wager adjustment module 130 receives, at step 502, the wager data from the modify module 116. For example, the wager data may be the user ID, such as JS123456, the wagered amount, such as $20, and the wager, such as J. D. Martinez, will hit a single in the first inning at-bat during the Boston Red Sox vs. the New York Yankees event. The wager adjustment module 130 compares, at step 504, the wager data to the modify database 132. For example, the wager adjustment module 130 compares the original wagered amount, such as $20, to the modify database 132 to determine the corresponding cost to modify, such as $4.50, and the percentage to decrease the odds on the next play by, such as 15%. Then the wager adjustment module 130 extracts, at step 506, the cost for modifying the wager. For example, the wager adjustment module 130 extracts the corresponding cost to modify the wager. For example, if the user wagered $20, the cost to modify would be $4.50. Then the wager adjustment module 130 determines, at step 508, the wager amount remaining. For example, the wager adjustment module 130 subtracts the cost to modify, such as $4.50, from the original amount wagered, such as $20, resulting in a $15.50 amount remaining for the user to wager on the next play. The wager adjustment module 130 extracts, at step 510, the percentage to decrease the odds from the modify database 132. For example, the wager adjustment module 130 extracts the corresponding percentage to decrease the odds for the next play. For example, if the user wagered $20, the odds would decrease by 15% on the next play. Then the wager adjustment module 130 extracts, at step 512, the odds for the next wager in the odds database 124. For example, the next play may the at-bat for Xander Bogaerts in the first inning in the Boston Red Sox vs. the New York Yankees, with the odds for Xander Bogaerts to hit a single being 6:1. In some embodiments, the odds may also include for Xander Bogaerts to hit a single, double, triple, home run, walk, strikeout, ground out, or flyout. The wager adjustment module 130 determines, at step 514, the new odds for the next wager. For example, if the odds for Xander Bogaerts to hit a single were 6:1, they would be decreased by 15%, creating new odds for user ID JS12345 of 5.1:1. Then the wager adjustment module 130 sends, at step 516, the cost for modifying the wager, the wager amount remaining, and the odds for the next wager to the modify module 116. For example, the wager adjustment module 130 the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The wager adjustment module 130 continuously polls, at step 518, for the new wager data from the modify module 116. For example, the wager adjustment module 130 is continuously polling for the new wager data, such as $15.50 on 5.1:1 for Xander Bogaerts to hit a single in the first inning of the Boston Red Sox vs. the New York Yankees event. Then the wager adjustment module 130 receives, at step 520, the new wager data from the modify module 116. For example, the wager adjustment module 130 receives the new wager data, such as $15.50 on 5.1:1 for Xander Bogaerts to hit a single in the first inning of the Boston Red Sox vs. the New York Yankees event. The wager adjustment module 130 stores, at step 522, the new wager data in the user database 120, and the process returns to continuously polling for the wager data from the modify module 116.

FIG. 6 illustrates the modify database 132. The database contains the original wager amount, the cost to modify the wager, and the percentage to decrease the odds. In some embodiments, the cost to modify the wager may be a percentage of the original amount or a predetermined number. In some embodiments, the percentage to decrease the odds may be determined on the original odds; for example, the higher the odds, the more they are decreased. In some embodiments, the database may contain a list of available wagers that the user can wager to prevent the user from selecting wagers with uncommonly high odds. Finally, in some embodiments, the database may contain a limit on the number of times a user can modify a wager.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of modifying a wager after wager statistics are displayed on an in-play wagering network, comprising;
receiving, from a user device, a wager on a an action of a live sporting event;
determining wager statistics related to the wager received from the user device;
displaying the wager statistics on the user device;
allowing a user associated with the user device to select to modify the wager; and
providing a cost to modify the wager and odds for the modified wager.

2. The method of modifying a wager after wager statistics are displayed on the in-play wagering network of claim 1, further comprising sending a notification to the user device with the cost to modify the wager and the odds for the modified wager, and
displaying an offer to accept or decline the modified wager.

3. The method of modifying a wager after wager statistics are displayed on the in-play wagering network of claim 2, wherein the wager statistics are determined by one or more real-time sensors at the live sporting event.

4. The method of modifying a wager after wager statistics are displayed on the in-play wagering network of claim 2, further comprising filtering an odds database for all wagers placed on the same play as the wager placed by the user,
wherein the wager statistics are the number of users that placed wagers on wagers on the same play as the wager placed by the user.

5. The method of modifying a wager after wager statistics are displayed on the in-play wagering network of claim 2, wherein the wager statistics displayed include all possible outcomes of the play on which the user placed a wager.

6. The method of modifying a wager after wager statistics are displayed on the in-play wagering network of claim 2, wherein the wager statistics include one or more of an amount of money that was wagered on each wager, an increase or decrease in percentages of the odds since the wager was offered, and an amount of time the wager has been offered.

7. The method of modifying a wager after wager statistics are displayed on the in-play wagering network of claim 2, wherein, when allowing the user to select to modify the wager, a limited list of wagers is provided from which the user may select.

8. The method of modifying a wager after wager statistics are displayed on the in-play wagering network of claim 2, further comprising checking how many wagers the user has modified,
wherein, if the user has modified more than a predetermined threshold of wagers within a predetermined amount of time, the user is prevented from modifying any more wagers.

9. A system for modifying a wager after wager statistics are displayed on an in-play wagering network, comprising;
a live event upon which play-by-play wagers can be placed;
a user device;
an in-play wagering network which offers wagers on the live sporting event and is communicatively connected to the user device;
a wager module which allows the user device to select a wager on the wagering network, receives wagers from a wager statistics module, and displays wager statistics to the user device;
the wager statistics module, which determines wager statistics related to the wager received from the user device;
a wager adjustment module which allows the user device to select to modify the wager and determines a cost to modify the wager and odds for the modified wager from a modify database; and
the modify database which contains data on the cost to modify the wager and the odds for the modified wager.

10. The system for modifying a wager after wager statistics are displayed on the in-play wagering network of claim 9, further comprising a modify module which sends a notification to the user device with the cost to modify the wager and the odds for the modified wager, and allows the user device to accept or decline the modified wager.

11. The system for modifying a wager after wager statistics are displayed on the in-play wagering network of claim 10, wherein the wager statistics are determined by one or more real-time sensors at the live sporting event.

12. The system for modifying a wager after wager statistics are displayed on the in-play wagering network of claim 10, further comprising an odds database which filters all wagers placed on the same play as the wager placed by the user device, and
wherein the wager statistics are the number of users that placed wagers on wagers on the same play as the wager placed by the user.

13. The system for modifying a wager after wager statistics are displayed on the in-play wagering network of claim 10, wherein the wager statistics displayed include all possible outcomes of the play the user placed a wager on.

14. The system for modifying a wager after wager statistics are displayed on the in-play wagering network of claim 10, wherein the wager statistics include one or more of an amount of money that was wagered on each wager, an increase or decrease in percentages of the odds since the wager was offered, and an amount of time the wager has been offered.

15. The system for modifying a wager after wager statistics are displayed on the in-play wagering network of claim 10, wherein when the wager adjustment module allows the user device to select to modify the wager, a limited list of wagers is provided for selection.

16. The system for modifying a wager after wager statistics are displayed on the in-play wagering network of claim 10, wherein the wager adjust module checks how many wagers the user has modified and if the user has modified more than a predetermined threshold of wagers within a predetermined amount of time the user is prevented from modifying any more wagers.
